(19) United States
(12) Patent Application Publication
(10) Pub. No.: US 2023/0410013 A1
(43) Pub. Date: Dec. 21, 2023

(54) CALCULATION APPARATUS, CALCULATION METHOD AND PROGRAM

(71) Applicant: NIPPON TELEGRAPH AND TELEPHONE CORPORATION, Tokyo (JP)

(72) Inventors: Atsushi NAKADAIRA, Tokyo (JP); Shigeru FUJIMURA, Tokyo (JP); Shigenori OHASHI, Tokyo (JP); Keita SUZUKI, Tokyo (JP); Honoka TODA, Tokyo (JP)

(21) Appl. No.: 18/248,411

(22) PCT Filed: Nov. 10, 2020
(86) PCT No.: PCT/JP2020/041947

§ 371 Date: Apr. 10, 2023

(51) Int. Cl. G06Q 10/0635; G06Q 40/03

(52) U.S. Cl. CPC G06Q 10/0635; G06Q 40/03

(57) ABSTRACT

A calculation apparatus according to an embodiment includes: an input unit that inputs information indicating a first action expected to be performed by a first user, information indicating a second action expected to be performed by a second user, information regarding the first user, information regarding the second user, and information indicating a relationship between the first user and the second user; and an expected value calculation unit that calculates an expected value indicating reliability with which the second user performs the second action when the first user performs the first action by using the information indicating the first action, the information indicating the second action, the information regarding the first user, the information regarding the second user, and the information indicating the relationship.

### TECHNICAL FIELD

The present invention relates to a calculation apparatus, a calculation method, and a program.

### BACKGROUND ART

It is assumed that transactions between individuals and small-to-medium-sized enterprises increase due to global connections between individuals. In addition, even for companies, it is assumed that transactions with companies in other countries far away increase. In order to implement such a transaction, it is necessary to be able to make a contract with mutual reliability in terms of fulfilment of the contract.

As a conventional technique, there is known a technique of calculating a credit status regarding payment of an individual or a company as a score and evaluating the score (for example, Non Patent Literature 1). Such a score (degree of credibility or degree of reliability) is mainly calculated from a payment record or the like of a user, and is used as an index indicating an expected value of payment.

### CITATION LIST

### Non Patent Literature

Non Patent Literature 1: the Ministry of Internal Affairs and Communications, “the 2018 White Paper on Information and Communications in Japan”, Internet <URL: https://www.soumu.go.jp/johotsusintokei/whitepaper/ja/h30/pdf/n2700000.pdf>

### SUMMARY OF INVENTION

### Technical Problem

However, since the degree of reliability is mainly based on a payment action of the user, the accuracy of the degree of reliability may be low for actions other than payment. In addition, the degree of reliability may be applied to various actions other than payment, whereby the degree of reliability is treated as if it is an evaluation of personality, which may lead to discrimination, prejudice, or the like.

An embodiment of the present invention has been made in view of the above points, and an object thereof is to calculate an expected value according to the type of action.

### Solution to Problem

In order to achieve the above object, a calculation apparatus according to an embodiment includes: an input unit that inputs information indicating a first action expected to be performed by a first user, information indicating a second action expected to be performed by a second user, information regarding the first user, information regarding the second user, and information indicating a relationship between the first user and the second user; and an expected value calculation unit that calculates an expected value indicating reliability with which the second user performs the second action when the first user performs the first action by using the information indicating the first action, the information indicating the second action, the information regarding the first user, the information regarding the second user, and the information indicating the relationship.

### Advantageous Effects of Invention

It is possible to calculate an expected value according to the type of action.

### BRIEF DESCRIPTION OF DRAWINGS

FIG. 1 is a diagram illustrating an example of a hardware configuration of a calculation device according to the present embodiment.

FIG. 2 is a diagram illustrating an example of a functional configuration of the calculation device according to the present embodiment.

FIG. 3 is a flowchart illustrating an example of a flow of processing executed by the calculation device according to the present embodiment.

### DESCRIPTION OF EMBODIMENTS

Hereinafter, an embodiment of the present invention will be described. In the present embodiment, it is assumed that a contract is made such that A and B, who are individuals or juridical persons, mutually perform a certain action, and a calculation device 10 will be described that is capable of calculating an expected value according to the type of action. In addition, at this time, a case where the executability of the action is also calculated by use of the expected value, a case where a notification is made when there is a difference in ability between A and B, and the like will also be described.

Here, the expected value does not necessarily mean a mathematical expected value, but indicates an index value such as a degree of reliability or a reliability score indicating how reliable one is for the other. That is, in a case where a contract is made between A and B such that A performs an action x and B performs an action y, the expected value indicates, for example, a degree of reliability, a reliability score, or the like indicating a possibility that B performs the action y when A performs the action x. In other words, the expected value is a concept in which a degree of reliability or a reliability score is extended even for any action other than a payment action.

Typically, in a case where the action x is payment of money and the action y is provision of a certain service or delivery of a certain product, the expected value is an index value indicating that the provision of the service or the delivery of the product is performed as expected when A pays money. Therefore, for example, even in a case where there is a high possibility that the quality of the service or the product is low (typically, in a case where there is a high possibility that the product is a defective product, for example), the expected value is low.

In addition, the action is an action as a purpose of the contract, and is, for example, an action of paying money, an action of delivering a product, an action of providing a service, or the like. The executability indicates an index value indicating a possibility that a certain action is actually performed when an expected value according to the action is obtained.

Note that, hereinafter, it is assumed that a contract is made (alternatively, a review, a determination, or the like regarding the contract is made) between A and B such that A performs the action x and B performs the action y, and it is assumed that an expected value f_{A,x}(B, y) at which B performs the action y when A performs the action x is calculated. At this time, A is also referred to as a “trusting person” because A is in a position to trust that B performs the action y. On the other hand, B is also referred to as a “trusted person” because B is in a position to be trusted by A.

<Hardware Configuration>

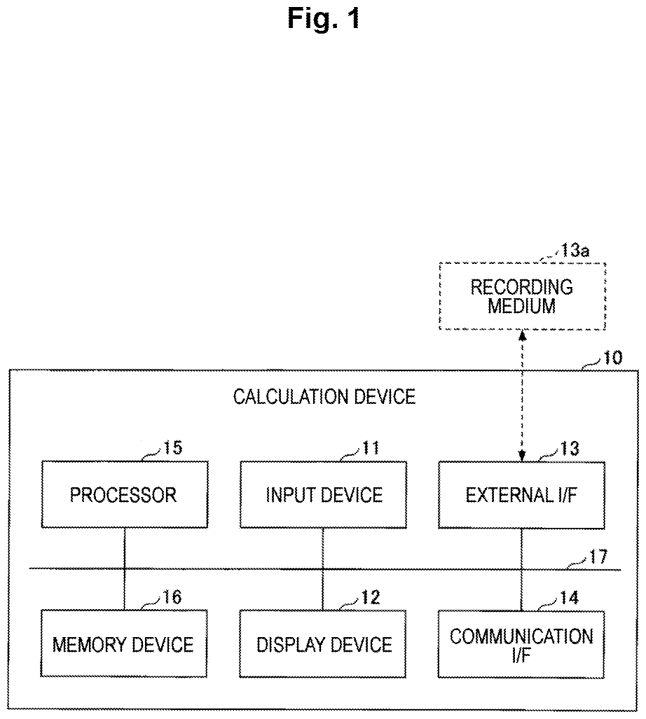

First, a hardware configuration of the calculation device 10 according to the present embodiment will be described with reference to FIG. 1. FIG. 1 is a diagram illustrating an example of the hardware configuration of the calculation device 10 according to the present embodiment.

As illustrated in FIG. 1, the calculation device 10 according to the present embodiment is implemented by a hardware configuration of a general computer or computer system, and includes an input device 11, a display device 12, an external I/F 13, a communication I/F 14, a processor 15, and a memory device 16. These pieces of hardware are communicably connected via a bus 17.

The input device 11 is, for example, a keyboard, a mouse, a touch panel, or the like. The display device 12 is, for example, a display or the like. Note that the calculation device 10 may not include, for example, at least one of the input device 11 and the display device 12.

The external I/F 13 is an interface with an external device such as a recording medium 13a. The calculation device 10 can, for example, read from and write in the recording medium 13a via the external I/F 13. Note that examples of the recording medium 13a include a compact disc (CD), a digital versatile disk (DVD), a secure digital memory card (SD memory card), a universal serial bus (USB) memory card, and the like.

The communication I/F 14 is an interface for connecting the calculation device 10 to a communication network. The processor 15 is, for example, an arithmetic device of various types such as a central processing unit (CPU) and a graphics processing unit (GPU). The memory device 16 is, for example, a storage device of various types such as a hard disk drive (HDD), a solid state drive (SSD), a random access memory (RAM), a read only memory (ROM), and a flash memory.

The calculation device 10 according to the present embodiment has the hardware configuration illustrated in FIG. 1, and thus can implement various types of processing to be described later. Note that the hardware configuration illustrated in FIG. 1 is an example, and the calculation device 10 may have another hardware configuration. For example, the calculation device 10 may include a plurality of processors 15 or a plurality of memory devices 16.

<Functional Configuration>

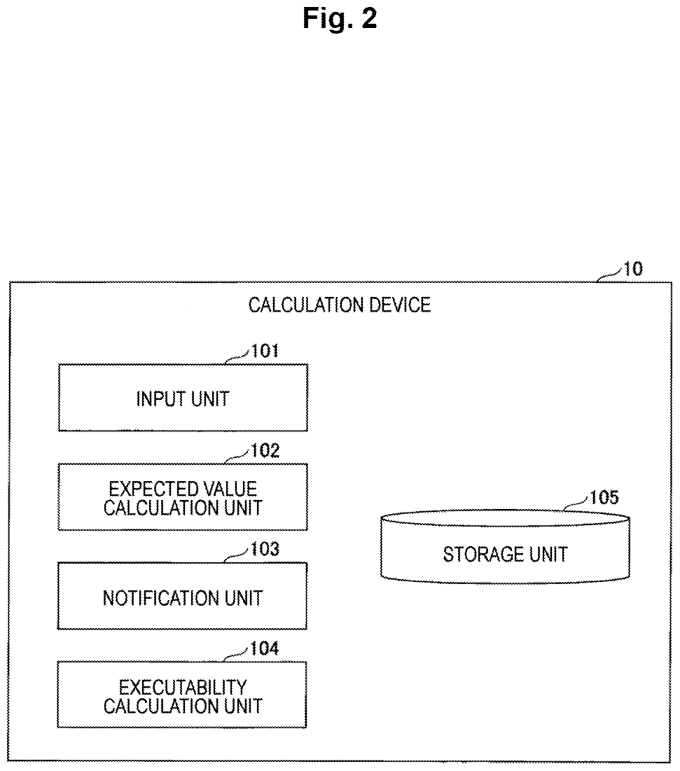

Next, a functional configuration of the calculation device 10 according to the present embodiment will be described with reference to FIG. 2. FIG. 2 is a diagram illustrating an example of the functional configuration of the calculation device 10 according to the present embodiment.

As illustrated in FIG. 2, the calculation device 10 according to the present embodiment includes an input unit 101, an expected value calculation unit 102, a notification unit 103, and an executability calculation unit 104. Each of these units is implemented, for example, by processing executed by the processor 15 by one or more programs installed in the calculation device 10.

In addition, the calculation device 10 according to the present embodiment includes a storage unit 105. The storage unit 105 is implemented by, for example, the memory device 16. Note that the storage unit 105 may be implemented by, for example, a storage device (database server or the like) connected to the calculation device 10 via a communication network.

The storage unit 105 stores information regarding the trusting person (hereinafter, also referred to as “trusting person information”), information regarding the trusted person (hereinafter, also referred to as “trusted person information”), information regarding a relationship between the trusting person and the trusted person (hereinafter, also referred to as “relationship information”), and the like.

Here, the trusting person information is information indicating various attributes of the trusting person, and includes, for example, information indicating various attributes listed below.
Ability of the trusting person
Reliability of the trusting person (honesty, cooperativity, altruism, or the like)
Social intelligence of the trusting person
Propensity of the trusting person
Sense of values of the trusting person The trusted person information is information indicating various attributes of the trusted person, and includes, for example, information indicating various attributes listed below.
Ability of the trusted person
Reliability of the trusted person (honesty, cooperativity, altruism, or the like)
Social intelligence of the trusted person
Propensity of the trusted person
Sense of values of the trusted person The relationship information is information indicating a personal or social relationship between the trusting person and the trusted person, and includes, for example, information indicating various relationships listed below.
Presence or absence of a debt of gratitude between the trusting person and the trusted person, and a degree thereof
Presence or absence of a blood relationship between the trusting person and the trusted person, and a degree thereof
Social standing or professional reliability of the trusting person and the trusted person
Social relationship between the trusting person and the trusted person (for example, a relationship between a doctor and a patient, a relationship between a teacher and a student, a relationship between a boss and a subordinate, or the like)
Evaluation of the ability of the trusted person made by the trusting person (or evaluation of the ability of the trusting person made by the trusted person) Note that each piece of information included in the trusting person information, the trusted person information, and the relationship information is an example, and various types of information indicating attributes of the trusting person, attributes of the trusted person, and relationships between the trusting person and the trusted person may be included in addition to the above-described information.

Furthermore, the relationship information may include information indicating a relationship between the trusting person and the trusted person via a third party (that is, an indirect relationship). Examples of the information indicating an indirect relationship include, for example, relationship information or the like between the trusted person and a third party belonging to an organization, a group, a community, or the like to which the trusted person belongs. Alternatively, for example, the information indicating an indirect relationship may be information or the like indicating an evaluation of the trusted person made by the third party.

The input unit 101 inputs information indicating the action x of the trusting person, information indicating the action y of the trusted person, the trusting person information, the trusted person information, and the relationship information. Note that the information indicating the action x and the information indicating the action y may be input from, for example, the input device 11 or the like, or may be input by being read from the storage unit 105. Meanwhile, the trusting person information, the trusted person information, and the relationship information are input by being read from the storage unit 105.

The expected value calculation unit 102 calculates the expected value f_{A,x}(B, y) at which the trusted person performs the action y when the trusting person performs the action x by using the information indicating the action x of the trusting person, the information indicating the action y of the trusted person, the trusting person information, the trusted person information, and the relationship information.

In a case where a predetermined notification condition is satisfied, the notification unit 103 outputs a notification indicating that the notification condition is satisfied to the trusting person. Here, examples of the notification condition include a case where a difference between the ability of the trusting person and the ability of the trusted person is equal to or larger than a predetermined difference. This is, for example, to prevent one from performing some sort of deception or fraudulent action on the other in a case where a difference in ability in the field covered by the contract is equal to or larger than a predetermined difference (that is, in a case where there is an ability gap).

Note that specific examples of the ability include an ability of a translation target language in a contract for commissioning/undertaking translation work of a software manual. In this case, for example, in a case where the ability of the trusting person is extremely lower than the ability of the trusted person, the trusting person cannot check a product (translated software manual), and thus has a risk of being deceived or defrauded, for example. Other specific examples of the ability include an ability to pay money.

The executability calculation unit 104 calculates an executability with which the trusted person actually performs the action y by using the expected value f_{A,x}(B, y).

<Flow of Processing>

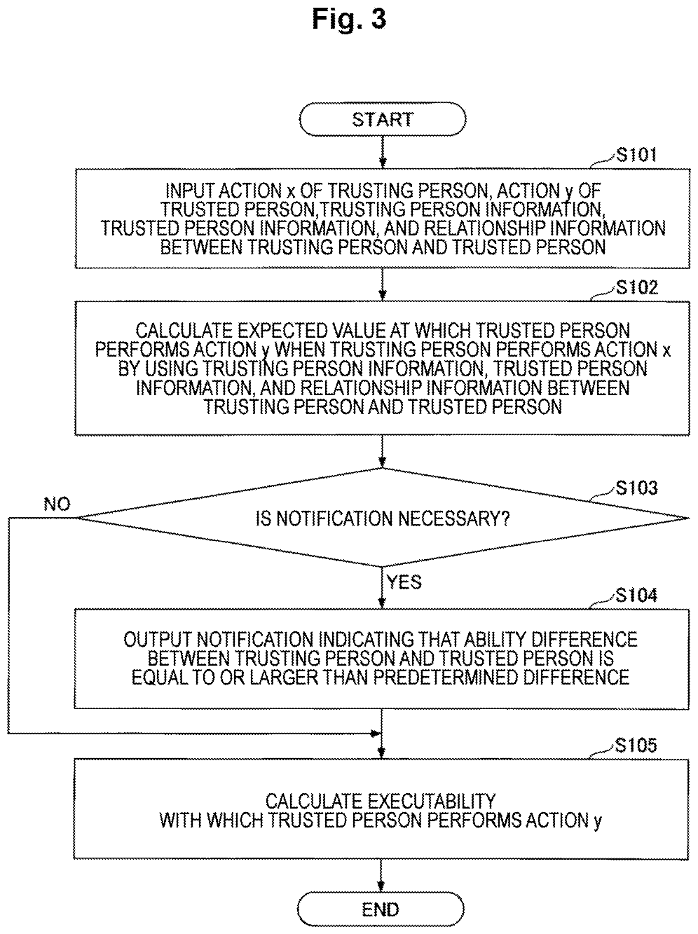

Next, a flow of processing executed by the calculation device 10 according to the present embodiment will be described with reference to FIG. 3. FIG. 3 is a flowchart illustrating an example of the flow of the processing executed by the calculation device 10 according to the present embodiment.

First, the input unit 101 inputs information indicating the action x of the trusting person, information indicating the action y of the trusted person, trusting person information, trusted person information, and relationship information between the trusting person and the trusted person (step S101).

Next, the expected value calculation unit 102 calculates the expected value f_{A,x}(B, y) at which the trusted person performs the action y when the trusting person performs the action x by using the information indicating the action x of the trusting person, the information indicating the action y of the trusted person, the trusting person information, the trusted person information, and the relationship information. (step S102). Here, a method of calculating the expected value f_{A,x}(B, y) can be variously considered, and for example, a method of calculating the expected value f_{A,x}(B, y) by a weighted sum of pieces of information indicating the following items can be considered. The value of a weight used for the weighted sum is determined in advance according to emphasized information. Note that it is assumed that each of the pieces of information indicating the following items is expressed by a numerical value by a known method.
Social intelligence of the trusting person
Information indicating the propensity of the trusting person
Sense of values of the trusting person
Ability of the trusting person regarding the action x
Ability of the trusted person regarding the action y
Reliability of the trusted person
Presence or absence of a debt of gratitude between the trusting person and the trusted person, and a degree thereof
Presence or absence of a blood relationship between the trusting person and the trusted person, and a degree thereof
Social standing or professional reliability of the trusting person and the trusted person
Social relationship between the trusting person and the trusted person

Here, the ability of the trusting person regarding the action x is an ability necessary for performing the action x among the ability of the trusting person. Similarly, the ability of the trusted person regarding the action y is an ability necessary for performing the action y among the ability of the trusted person. Specifically, for example, in a case where the action x is “payment of money”, the ability regarding the action x is a payment ability or the like. Furthermore, for example, in a case where the action y is “translation of a software manual”, the ability regarding the action y is a translation skill, a software development skill, or the like.

Note that calculating the expected value f_{A,x}(B, y) by the weighted sum is an example, and the expected value f_{A,x}(B, y) may be calculated by other various methods.

Furthermore, the information used for calculating the expected value f_{A,x}(B, y) is not limited to the above, and various information can be used. For example, as described above, information indicating an indirect relationship between the trusting person and the trusted person may be used. However, it is preferable to use at least information indicating the ability of the trusting person regarding the action x and information indicating the ability of the trusted person regarding the action y.

Next, the notification unit 103 determines whether or not a predetermined notification condition is satisfied (step S103). As described above, examples of the notification condition include a case where a difference between the ability of the trusting person and the ability of the trusted person is equal to or larger than a predetermined difference. Specifically, for example, in a case where the trusting person commissions the trusted person to perform a certain type of work (for example, translation work or the like of a software manual) as the action y, it is conceivable to set a notification condition that a difference between the ability of the trusting person regarding the action y and the ability of the trusted person regarding the action y is equal to or larger than a predetermined difference.

In a case where it is determined in step S103 described above that the notification condition is satisfied, the notification unit 103 outputs a notification indicating that the notification condition is satisfied (step S104). For example, the notification unit 103 notifies the trusting person (alternatively, the trusted person or both of them) that the difference between the ability of the trusting person and the ability of the trusted person is equal to or larger than the predetermined difference.

In a case where it is not determined in step S103 described above that the notification condition is satisfied, or following step S104, the executability calculation unit 104 calculates an executability with which the trusted person actually performs the action y by using the expected value f_{A,x}(B, y) calculated in step S102 described above (step S105). Here, a method of calculating the executability can be variously considered, and for example, a method of correcting the expected value f_{A,x}(B, y) by use of information indicating the following items can be considered (for example, the expected value f_{A,x}(B, y) is multiplied by the information indicating the following items, so that correction is performed). Furthermore, at this time, for example, normalization may be performed such that the executability becomes a value of 0 or more and 1 or less.
Honesty of the trusted person
Evaluation of the ability of the trusted person made by the trusting person regarding the action y
Information regarding a relationship between the trusting person and the trusted person

Here, the information indicating the honesty of the trusted person is included in the information indicating the reliability of the trusted person. In addition, the evaluation of the ability of the trusted person made by the trusting person regarding the action y is an evaluation of the ability regarding the action y among the evaluation of the ability of the trusted person made by the trusting person. Specifically, for example, in a case where the action y is “translation of a software manual”, the evaluation of the ability of the trusted person made by the trusting person regarding the action y is an evaluation of the work of “translation of a software manual” that has been undertaken by the trusted person so far, which is made by the trusting person.

Note that the information used to calculate the executability is not limited to the above, and various types of information can be used. For example, information indicating an evaluation of the ability of the trusted person made by a third party regarding the action y may be used. Furthermore, for example, information indicating a temporal condition or a deadline regarding the action y (for example, a delivery deadline of a product or the like), information indicating a difficulty level of the action y, or the like may be used. In addition, for example, information indicating the reliability of the trusted person other than the honesty (that is, for example, cooperativity, altruism, or the like) may be used.

### SUMMARY

As described above, the calculation device 10 according to the present embodiment can calculate the expected value f_{A,x}(B, y) at which the trusted person performs the action y when the trusting person performs the action x by using the trusting person information, the trusted person information, and the relationship information between the trusting person and the trusted person. As a result, in a case where the trusting person and the trusted person make a contract promising that the trusting person performs the action x and the trusted person performs the action y, the trusting person can determine, from the expected value, to what degree the trusted person can be expected (trusted) to perform the action y as expected by the trusting person.

As described above, the calculation device 10 according to the present embodiment can calculate the expected value indicating to what degree a type of action can be trusted to be performed by using a personal evaluation value that does not depend on the type of action (for example, reliability, propensity, sense of values, blood relationship, social standing, occupation, social relationship, or the like) and an evaluation value according to the type of action (for example, ability regarding the action, or the like). This expected value is an index value evaluated from various viewpoints, and is an index value evaluated even from a viewpoint according to the type of action, unlike a degree of reliability calculated in the conventional technique. In addition, the evaluation of the trusted person is dependent on the information of the trusting person and the relationship information between the trusting person and the trusted person, and thus is not necessarily a single evaluation for every person. For these reasons, the calculation device 10 has a characteristic that the evaluation is less likely to lead to discrimination, prejudice, or the like.

Furthermore, the calculation device 10 according to the present embodiment can also calculate the executability with which the trusted person performs the action y by using the expected value calculated as described above. As a result, the trusting person can accurately predict to what degree the action y will actually be performed in consideration of the past record of the trusted person and the specific characteristics of the action y (deadline, difficulty level, or the like).

The present invention is not limited to the above-described specifically disclosed embodiment, and various modifications and changes, combinations with known techniques, and the like can be made without departing from the scope of the claims.

### REFERENCE SIGNS LIST

10 Calculation device
11 Input device
12 Display device
13 External I/F
13a Recording medium
14 Communication I/F
15 Processor
16 Memory device
17 Bus
101 Input unit
102 Expected value calculation unit
103 Notification unit
104 Executability calculation unit
105 Storage unit

1. A calculation apparatus comprising:
circuitry configured to
input
first information indicating a first action expected of a first user,
second information indicating a second action expected of a second user,
third information associated with the first user,
fourth information associated with the second user, and
fifth information indicating a relationship between the first user and the second user, and
calculate an expected value using the first information, the second information, the third information, the fourth information, and the fifth information, the expected value indicating reliability with which the second user performs the second action in a case where the first user performs the first action.

2. The calculation apparatus according to claim 1, wherein the circuitry is configured to calculate an executability indicating a degree to which the second user performs the second action, based on the expected value and sixth information, the sixth information indicating an ability evaluation of the second user that is in association with the second action.

3. The calculation apparatus according to claim 2, wherein the circuitry is configured to calculate, based on the expected value and the sixth information, the executability by using at least one of:
information indicating honesty of the second user,
information indicating cooperativity of the second user,
information indicating altruism of the second user,
information of a temporal condition, or a deadline, for the second action, or
information indicating a difficulty level of the second action.

4. The calculation apparatus according to claim 1, wherein the fifth information includes information indicating an indirect relationship between the first user and the second user, the indirect relationship being enabled with a participation by a third party.

5. The calculation apparatus according to claim 1, wherein the third information includes first ability information of the first user, and the fourth information includes second ability information of the second user, and
wherein the circuitry is configured to
determine whether an ability difference between the first user and the second user is greater than or equal to a threshold based on the first ability information of the first user and the second ability information of the second user, and
output a notification to at least one of the first user or the second user, upon determining that the ability difference is greater than or equal to the threshold.

6. A calculation method executed by a computer, the calculation method comprising:
inputting
first information indicating a first action expected of a first user,
second information indicating a second action expected of a second user,
third information associated with the first user,
fourth information associated with the second user, and
fifth information indicating a relationship between the first user and the second user; and
calculating an expected value using the first information, the second information, the third information, the fourth information, and the fifth information, the expected value indicating reliability with which the second user performs the second action in a case where the first user performs the first action.

7. A non-transitory computer readable medium storing a program that causes a computer to execute the calculation method of claim 6.
